(19) United States
(12) Patent Application Publication
(10) Pub. No.: US 2024/0251702 A1
(43) Pub. Date: Aug. 1, 2024

(54) ROUTE GENERATOR AND MOWED GRASS COLLECTOR

(71) Applicant: HONDA MOTOR CO., LTD., Tokyo (JP)

(72) Inventors: Toshiro UCHIDA, Saitama (JP); Kota ONO, Saitama (JP); Naohide OGAWA, Saitama (JP)

(21) Appl. No.: 18/422,002

(22) Filed: Jan. 25, 2024

(30) Foreign Application Priority Data
Jan. 31, 2023 (JP) 2023-012973

(51) Int. Cl. A01D 34/00

(52) U.S. Cl. CPC A01D 34/008

(57) ABSTRACT

The present invention provides a route generator that can generate a travel route for a mowed grass collector to efficiently and reliably collect grass left after lawn mowing work, and a mowed grass collector. A route generator includes: a mowing information acquisition unit that acquires mower information including at least a direction in which grass mowed by a lawn mower is discharged; and a collection route generator unit that acquires a travel route of the lawn mower and generates a travel route for an autonomous mowed grass collector to collect the mowed grass based on the acquired travel route and the direction in which the mowed grass is discharged.

This application is based on and claims the benefit of priority from Japanese Patent Application No. 2023-012973, filed on 31 Jan. 2023, the content of which is incorporated herein by reference.

### BACKGROUND OF THE INVENTION

### Field of the Invention

The present invention relates to a route generator and a mowed grass collector.

### Related Art

A mowed grass collector is used to collect grass mowed by a lawn mower in farm work or maintenance of green spaces. For example, Patent Document 1 discloses a mowed grass collector of this kind.

Patent Document 1 shows an example of a self-propelled sweeper (mowed grass collector). The sweeper of Patent Document 1 includes a mowed grass collector unit that combs up, sucks, and transfer mowed grass, a separator unit that separates the mowed grass sent from the mowed grass collector unit together with the sucked air into the air to be discharged from an exhaust unit and the grass to be collected into a grass container, and a drive cleaning mechanism that cleans a grass separating filter of the separator unit by brushing off the grass adhered to the filter.

Patent Document 1: Japanese Unexamined Patent Application, Publication No. H6-316910

### SUMMARY OF THE INVENTION

An autonomous lawn mower is also used in view of improving work efficiency. The grass needs to be collected even after the lawn mowing by the autonomous lawn mower. If an autonomous mowed grass collector moves along a travel route of the lawn mower, the collection of the mowed grass can also be automated. However, the lawn mower may discharge the mowed grass in a lateral direction or behind. Although the autonomous mowed grass collector moves along the travel route of the lawn mower, the mowed grass may not be sufficiently collected depending on the direction in which the lawn mower discharges the grass.

An object of the present invention is to provide a route generator that can generate a travel route for a mowed grass collector to efficiently and reliably collect grass left after the lawn mowing work, and a mowed grass collector.

(1) A route generator of the present invention includes: a mowing information acquirer that acquires mower information including at least a direction in which grass mowed by a lawn mower is discharged; and a collection route generator that acquires a travel route of the lawn mower and generates a travel route for an autonomous mowed grass collector to collect the mowed grass based on the acquired travel route and the direction in which the mowed grass is discharged.

(2) The route generator according to (1), wherein the mower information may include a size of the lawn mower, and the collection route generator may acquire a size of the mowed grass collector to calculate a relative distance between the lawn mower and the mowed grass collector during collection of the mowed grass based on the size of the lawn mower, the size of the mowed grass collector, and the direction in which the grass is discharged, and may generate the travel route of the mowed grass collector based on the relative distance, the travel route of the lawn mower, and the direction in which the mowed grass is discharged.

(3) The route generator according to (2), wherein in a case where the mowed grass is discharged to one side in a lateral direction of the lawn mower, the collection route generator may generate the travel route of the mowed grass collector that is deviated from the travel route of the lawn mower to the one side in the lateral direction.

(4) The route generator according to any one of (1) to (3), wherein the mowing information acquirer further acquires work information for distinction between a section where lawn mowing work is performed and a section where no lawn mowing work is performed on the travel route, and the collection route generator may generate the travel route of the mowed grass collector reflecting the section where no lawn mowing work is performed so that a travel distance of the mowed grass collector is reduced.

(5) The route generator according to any one of (1) to (3), wherein the mowing information acquirer further acquires work information for distinction between a section where lawn mowing work is performed and a section where no lawn mowing work is performed on the travel route, and the collection route generator may set a section that corresponds to the section where no lawing mowing work is performed and requires no collection work on the travel route of the mowed grass collector.

(6) The route generator according to any one of (1) to (3) may further include: a weather information acquirer that acquires weather information; and a compression processor that determines a place to compress and discharge the mowed grass based on the weather information.

A mowed grass collector of the present invention includes a route generator including: a mowing information acquirer that acquires mower information including at least a direction in which grass mowed by a lawn mower is discharged; and a collection route generator that acquires a travel route of the lawn mower and generates a travel route for the mowed grass collector to collect the mowed grass based on the acquired travel route and the direction in which the mowed grass is discharged.

### BRIEF DESCRIPTION OF THE DRAWINGS

FIG. 1 is a schematic view illustrating a configuration of a lawn mowing system to which a server as a route generator according to an embodiment of the present invention is applied;

FIG. 2 is a plan view schematically illustrating a lawn mower that discharges mowed grass in a lateral direction and a mowed grass collector according to the present embodiment;

FIG. 3 is a functional block diagram of the lawn mower of the present embodiment;

FIG. 4 is a functional block diagram of the mowed grass collector of the present embodiment;

FIG. 5 is a functional block diagram of a server of the present embodiment;

FIG. 6 is a view illustrating an example of a travel route of the lawn mower from the start to end of work;

FIG. 7 is a plan view schematically illustrating a lawn mower that discharges mowed grass in a rear direction and a mowed grass collector;

FIG. 8 is a plan view illustrating an example of a travel route of the mowed grass collector reflecting work information of the lawn mower;

FIG. 9 is a flowchart of an example of a flow of a process of generating a travel route of the mowed grass collector;

FIG. 10 is a flowchart of an example of a flow of a compression process by the mowed grass collector; and

FIG. 11 is a functional block diagram of a controller of a mowed grass collector according to a variation.

### DETAILED DESCRIPTION OF THE INVENTION

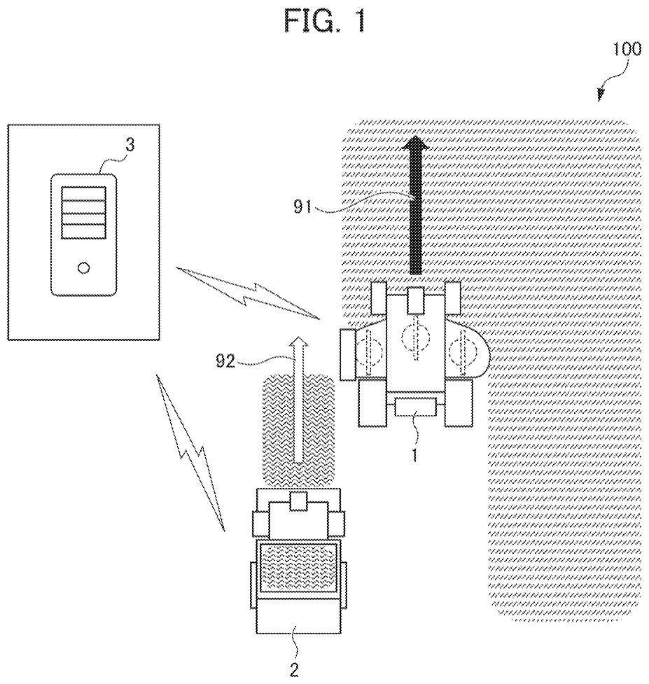

FIG. 1 is a schematic view illustrating a configuration of a lawn mowing system 100 to which a server 3, which is a route generator of an embodiment of the present invention, is applied. As shown in FIG. 1, the lawn mowing system 100 includes an autonomous lawn mower 1, an autonomous mowed grass collector 2, and a server 3 that manages travel routes of the lawn mower 1 and the mowed grass collector 2.

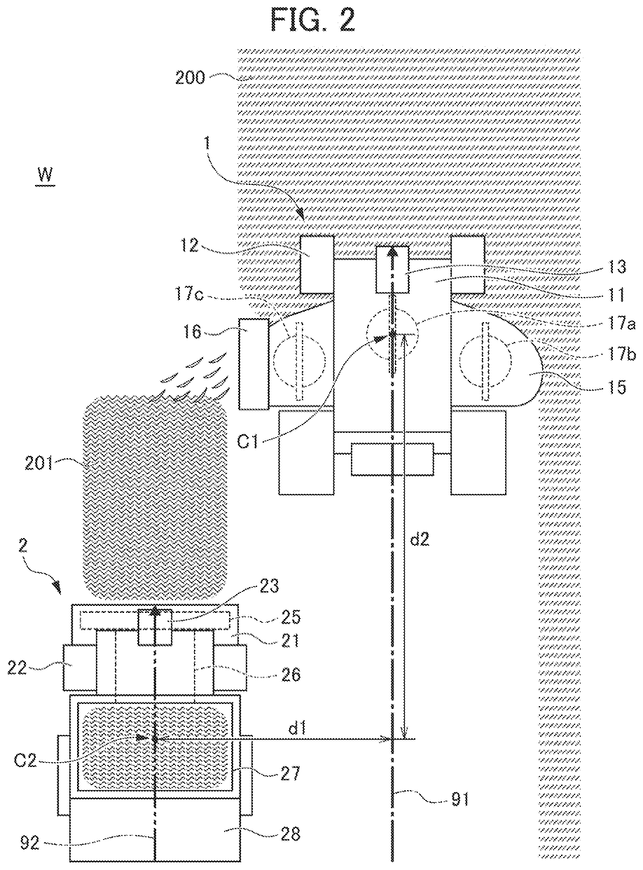

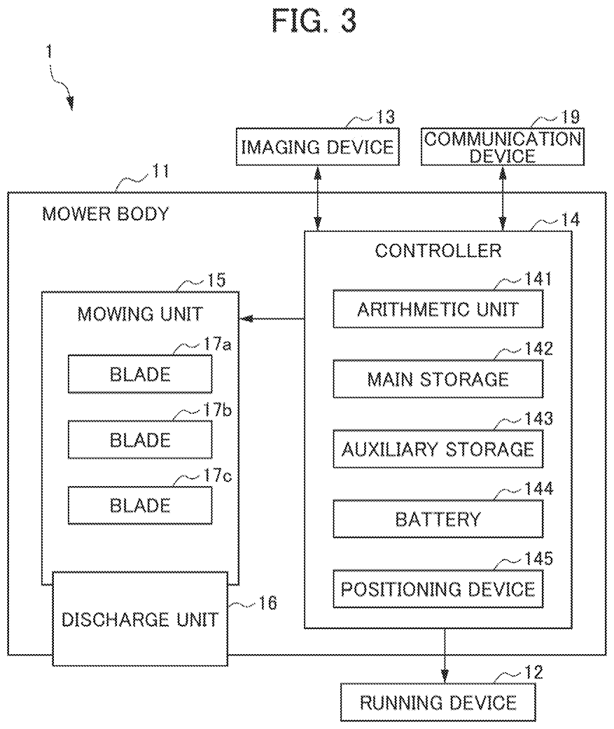

FIG. 2 is a plan view schematically illustrating the lawn mower 1 that discharges mowed grass in a lateral direction and the mowed grass collector 2 according to the present embodiment. FIG. 3 is a functional block diagram of the lawn mower 1 of the present embodiment.

The lawn mower 1 shown in FIGS. 2 and 3 is an autonomous mobile robot that performs lawn mowing work on vegetation 200 in a work area W. The lawn mower 1 includes a mower body 11, a running device 12, an imaging device 13, a controller 14, and a communication device 19.

The mower body 11 includes a mowing unit 15 that is a mechanism for mowing grass and a discharge unit 16 that discharges the grass mowed by the mowing unit 15 out of the mower body 11.

The mowing unit 15 includes multiple rotary blades 17a to 17c arranged at the bottom of the mower body 11. The blade 17a, which is one of the multiple blades 17a to 17c, is arranged at the center of a bottom surface of the mower body 11. In the following description, the center of the rotation axis of the blade 17a will be regarded as the center C1 of the lawn mower 1. The remaining two blades 17b and 17c are arranged to sandwich the blade 17a in the lateral direction. Both of the blades 17b and 17c are located rearward of the blade 17a in a longitudinal direction. When the blades 17a to 17c rotate, grass in the vegetation 200 is cut.

The discharge unit 16 discharges the grass mowed by the mowing unit 15 from the inside to outside of the mowing unit 15. FIG. 2 shows an example of the discharge unit 16 that discharges the mowed grass in the lateral direction, i.e., a side discharge unit. As will be described later, the lawn mower 1 runs along a travel route 91 that turns around to the right. Thus, as shown in FIG. 2, the discharge unit 16 is arranged on the left side of the lawn mower 1 to discharge the mowed grass to the left of the lawn mower 1. If the travel route 91 of the lawn mower 1 is set to turn around to the left, the discharge unit 16 is arranged on the right side of the lawn mower 1 to discharge the mowed grass to the right of the lawn mower 1.

The running device 12 allows the mower body 11 to move. The running device 12 includes, for example, a pair of left and right front wheels, a pair of left and right rear wheels, a motor that drives the wheels, and a mechanism for changing the travelling direction of the lawn mower.

The imaging device 13 is mounted on the mower body 11. An image taken by the imaging device 13 is transmitted to the controller 14 for control of autonomous movement.

The controller 14 is a computer that performs various types of control of the lawn mower 1 such as autonomous movement, a mowing action, and communication with the server 3. The controller 14 includes, for example, an arithmetic unit 141 such as a central processing unit (CPU) that performs arithmetic processing, a main storage 142 such as a random access memory (RAM) that stores data temporarily required for the arithmetic unit 141 to run a program, and an auxiliary storage 143 such as a hard disk drive (HDD) that stores application software and various control programs such as an operating system (OS). The controller 14 further includes a battery 144 that supplies electric power to the units of the lawn mower 1 and a positioning device 145 that determines the position of the lawn mower 1. The positioning device 145 is constituted of, for example, a receiver that receives a signal from a positioning satellite of a global navigation satellite system (GNSS) such as Global Positioning System (GPS) or an acceleration sensor.

The communication device 19 allows the lawn mower 1 to communicate with external devices. The lawn mower 1 transmits and receives various information items to and from the server 3 or the mowed grass collector 2 via the communication device 19.

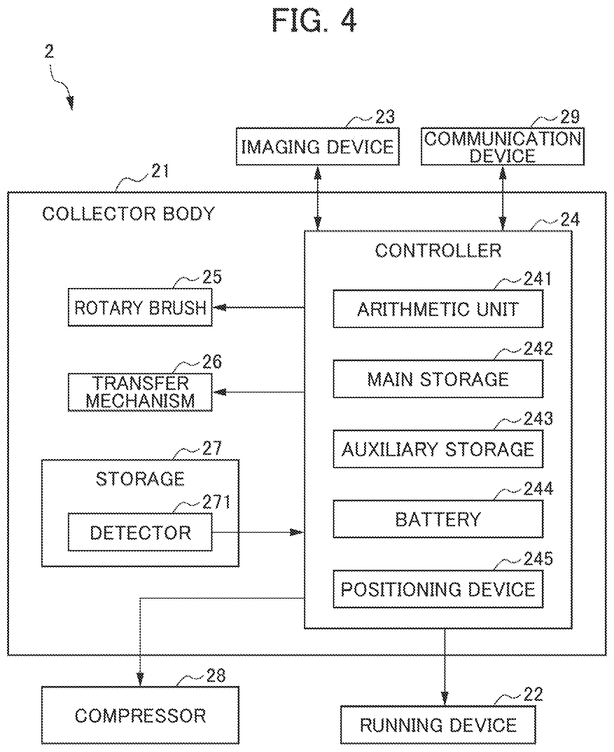

The mowed grass collector 2 will be described below. FIG. 4 is a functional block diagram of the mowed grass collector 2 of the present embodiment. The mowed grass collector 2 shown in FIGS. 2 and 4 is an autonomous mobile robot that collects an object (mowed grass) 201 discharged and left by the lawn mower 1 after the lawn mowing. The mowed grass collector 2 includes a collector body 21, a running device 22, an imaging device 23, a controller 24, a compressor 28, and a communication device 29.

The collector body 21 includes a rotary brush 25, a transfer mechanism 26, and a storage 27. The rotary brush 25 is a work unit that winds up the mowed grass left on the ground. The transfer mechanism 26 transfers the mowed grass collected from the ground by the rotary brush 25 to the storage 27. The transfer mechanism 26 may be, for example, a conveyor or a suction device. The storage 27 is a container that stores the collected grass. The storage 27 is provided with a detector 271 that is constituted of, for example, a sensor that mechanically or optically senses the amount of the collected grass.

The running device 22 allows the collector body 21 to move. The running device 22 includes, for example, a pair of left and right front wheels and a pair of left and right rear wheels, and is driven by a drive motor which is not shown and is incorporated in the collector body 21. The running device 22 also includes a mechanism for changing the travelling direction and is able to change the moving direction of the mowed grass collector 2.

The imaging device 23 is mounted on the collector body 21. An image taken by the imaging device 23 is transmitted to the controller 24 for control of autonomous movement.

The controller 24 is a computer that performs various types of control of the mowed grass collector 2 such as autonomous movement, a collecting action, and communication with the server 3. The controller 24 includes, for example, an arithmetic unit 241 such as CPU that performs arithmetic processing, a main storage 242 such as a random access memory (RAM) that stores data temporarily required for the arithmetic unit 241 to run a program, and an auxiliary storage 243 such as HDD that stores application software and various control programs such as OS. The controller 24 further includes a battery 244 that supplies electric power to the units of the mowed grass collector 2 and a positioning device 245 that determines the position of the mowed grass collector 2. The positioning device 245 is constituted of, for example, a receiver that receives a signal from a positioning satellite of GNSS such as GPS or an acceleration sensor.

The compressor 28 is a mechanism that compresses the mowed grass contained in the storage 27 into a roll shape. The compressor 28 includes, for example, multiple compression rollers, a reel, and a cutter. The multiple compression rollers sandwich and press the mowed grass into a sheet shape, the reel winds the sheet-shaped grass, and the cutter cuts the rolled grass to a predetermined length. Thus, a column-shaped grass roll is formed.

The communication device 29 allows the mowed grass collector 2 to communicate with external devices. The mowed grass collector 2 transmits and receives various information items to and from the server 3 or the lawn mower 1 via the communication device 29.

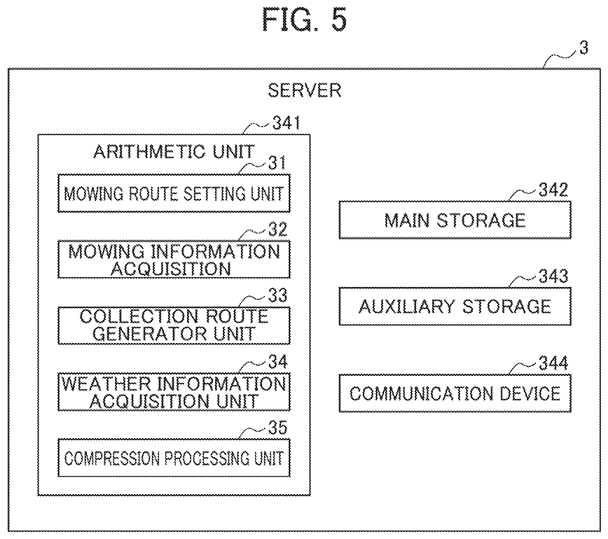

The server 3 will be described below. The server 3 is a computer that generates the travel route 91 of the lawn mower 1 and a travel route 92 of the mowed grass collector 2. FIG. 5 is a functional block diagram of the server 3 of the present embodiment.

As shown in FIG. 5, the server 3 includes, for example, an arithmetic unit 341 such as CPU that performs arithmetic processing, a main storage 342 such as RAM that stores data temporarily required for the arithmetic unit 341 to run a program, an auxiliary storage 343 such as HDD that stores application software and various control programs such as OS, and a communication device 344 that transmits and receives various information items to and from external devices.

The server 3 includes, as functional units operated by the arithmetic unit 341, a mowing route setting unit 31, a mowing information acquisition unit 32, a collection route generator unit 33, a weather information acquisition unit 34, and a compression processing unit 35.

The mowing route setting unit 31 sets the travel route 91 of the lawn mower 1. Teaching an outer periphery of the whole work area, for example, allows automatic generation of the travel route 91 as a running course that covers the whole part inside the work area. The mowing route setting unit 31 may store the travel route 91 taken when the user actually performed the lawn mowing work or work information indicating the progress of work and may operate the lawn mower 1 based on the travel route 91 and the work information.

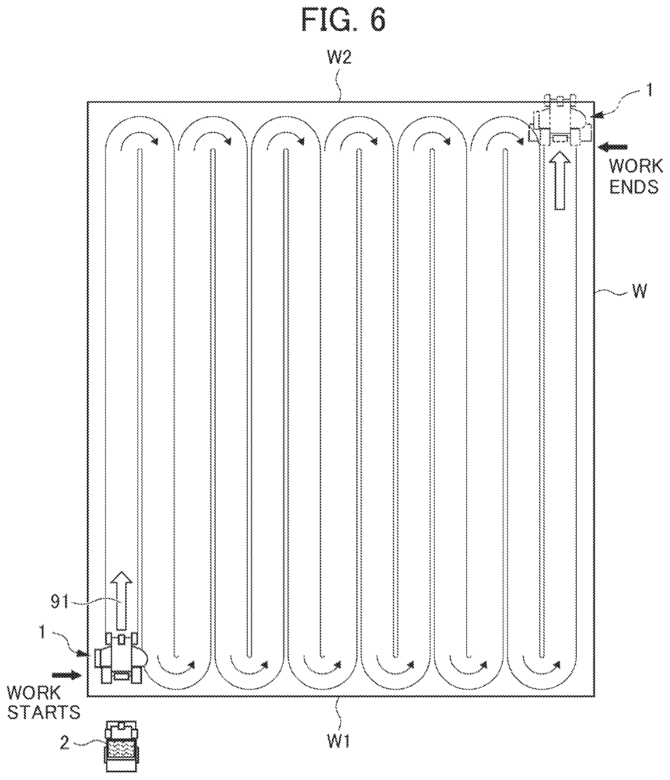

The travel route 91 of the lawn mower 1 will be described below with reference to FIG. 6. FIG. 6 is a view illustrating an example of the travel route 91 of the lawn mower 1 from the start to end of the work. FIG. 6 shows a rectangular-shaped work area W viewed in plan. The lawn mower 1 before starting the lawn mowing work stands by at a start position which is on the lower left corner of the work area W.

In this example, the lawn mower 1 linearly moves along the set travel route 91 from the lower side W1 to upper side W2 of the work area W, turns 180 degrees when reaching the upper side W2, and linearly moves back to the lower side W1. When reaching the lower side W1, the lawn mower 1 turns 180 degrees again and linearly moves to the upper side W2. The lawn mower 1 repetitively moves between the sides W1 and W2 from the start position to the end position to mow the grass in the whole work area W.

Referring back to FIG. 5, the other functional units will be described below. The mowing information acquisition unit 32 acquires mower information about the lawn mower 1 and work information about the operation of the lawn mower 1.

The mower information of the lawn mower 1 includes, for example, the size of the lawn mower 1, the number and length of the blades 17a to 17c, and the direction in which the mowed grass is discharged. The work information of the lawn mower 1 includes, for example, running speed, the operating status of the blades 17a to 17c such as the number of rotations, and the height of the blades 17 from the ground. The work information of the lawn mower 1 may be directly acquired from the lawn mower 1 in the lawn mowing work or may be acquired from the user's input. The mowing information acquisition unit 32 stores the acquired mower information and work information of the lawn mower 1 in the auxiliary storage 343 in association with the travel route 91.

The collection route generator unit 33 generates the travel route 92 of the mowed grass collector 2 based on the travel route 91 of the lawn mower 1, the direction in which the mowed grass is discharged, and a relative distance (separation distance) between the lawn mower 1 and the mowed grass collector 2.

Referring back to FIG. 2, the relative distance will be described below. The relative distance between the lawn mower 1 and the mowed grass collector 2 is set to keep the mowed grass collector 2 from making contact with the lawn mower 1. The relative distance is set so that the lawn mower 1 and the mowed grass collector 2 are within a range of near field communication such as Wi-Fi (registered trademark).

First, as shown in FIG. 2, the lawn mower that discharges the mowed grass in the lateral direction will be described below. When the mowed grass is discharged in the lateral direction, the relative distance in the lateral direction is set so that the mowed grass collector 2 deviates from the travel route 91 of the lawn mower 1 in the lateral direction (the width direction of the mowed grass collector 2).

The lateral deviation d1 is, for example, calculated by adding a length from the center C1 to an end in the width direction of the lawn mower 1, a length from the center C2 to an end in the width direction of the mowed grass collector 2, and a margin α. The end of the lawn mower 1 in the width direction may be a point away from the center of the rotation axis of the outer blade 17c by the radius of the blade 17c in the lateral direction. The length between the center of the mowed grass collector 2 and the end in the width direction may be a length between the center C2 of the mowed grass collector 2 and a point away from the center C2 by half the width of the mowed grass collector 2. The margin α is set to reliably avoid contact between the lawn mower 1 and the mowed grass collector 2.

In the longitudinal direction (traveling direction of the mower 1 or the mowed grass collector 2), the relative distance is set to a predetermined distance d2 (e.g., 2 m) to avoid direct contact between the mowed grass discharged from the lawn mower 1 and the mowed grass collector 2.

The relative distances to the lawn mower 1 in the longitudinal and lateral directions are set in this manner to determine the travel route 92 of the mowed grass collector 2. In this example, the mowed grass collector 2 follows the lawn mower 1 at a position obliquely behind the lawn mower 1 doing the lawn mowing work.

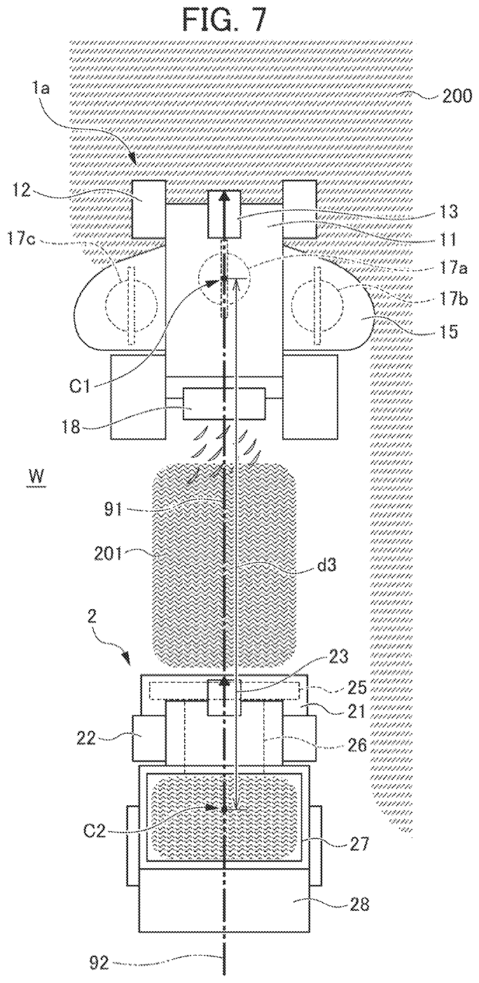

Referring to FIG. 7, the lawn mower that discharges the mowed grass not in the lateral direction but in the rear direction will be described below. FIG. 7 is a plan view schematically illustrating a lawn mower la that discharges the mowed grass in the rear direction and the mowed grass collector 2.

The lawn mower 1a shown in FIG. 7 is configured in the same manner as the lawn mower 1 shown in FIG. 2 except for a discharge unit 18. The components other than the discharge unit 18 will be indicated by the same reference numerals as those used above and will not be described in detail. FIG. 7 shows an example of the discharge unit 18 that is arranged on the rear side of the mower body 11 and discharges the mowed grass in the rear direction, i.e., a rear discharge unit.

When the mowed grass is discharged in the rear direction, the relative distance in the lateral direction is set to zero. Thus, the travel route 92 of the mowed grass collector 2 follows the travel route 91 of the lawn mower 1a. When the lawn mower 1a and the mowed grass collector 2 travel the same point, the center C1 of the lawn mower 1a and the center C2 in the width direction of the mowed grass collector 2 coincide.

When the mowed grass is discharged in the rear direction, the relative distance in the longitudinal direction is set to a predetermined distance d3 (e.g., 3 m) to avoid direct contact between the mowed grass discharged by the lawn mower 1a and the mowed grass collector 2. Since the mowed grass is discharged in the rear direction, the predetermined distance d3 is set longer than the predetermined distance d2 when the mowed grass is discharged in the lateral direction. The relative distances thus set allow the mowed grass collector 2 to follow the lawn mower 1a at a position behind the lawn mower 1a doing the lawn mowing work.

Irrespective of whether the mowed grass is discharged in the lateral direction or the rear direction, work information such as the running speed of the mowed grass collector 2 based on the travel route 92 of the mowed grass collector 2 and whether the rotary brush 25 works or not is set in accordance with the work information of the lawn mower 1.

A process of reflecting the work information in the travel route 92 will be described below. When the blades 17a to 17c of the mowing unit 15 are rotating on the travel route 91 of the lawn mower 1, the lawn mowing work is in progress. When the blades 17a to 17c are not rotating, the lawn mowing work is not performed, and no grass is discharged. Thus, when work information including information about the rotation of the blades 17a to 17c is reflected in the travel route 92 of the mowed grass collector 2, collection work can be achieved more efficiently by, for example, doing no collection work in a section of the travel route 91 where no grass is discharged or setting the travel route 92 that does not pass the section where no grass is discharged.

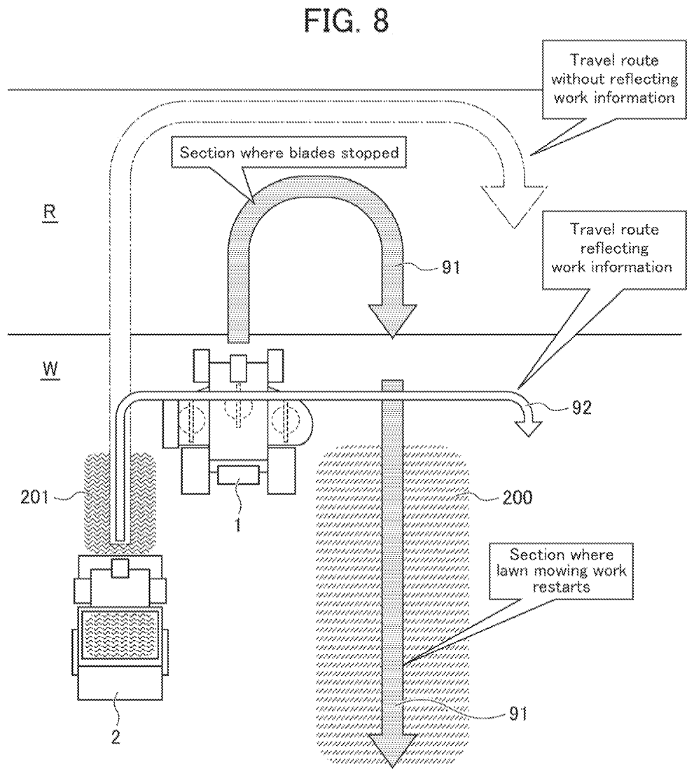

A process of setting the travel route 92 that does not pass the section where no grass is discharged will be described below with reference to FIG. 8. FIG. 8 is a plan view illustrating an example of the travel route 92 of the mowed grass collector 2 reflecting the work information of the lawn mower 1.

As shown in FIG. 8, when the lawn mower 1 moves out of the work area W to an asphalt road R and makes a U-turn to return to the work area W, the blades 17a to 17c stop rotating on the asphalt road R. This information can be obtained based on the work information including the information about the rotation of the blades 17a to 17b. Thus, the travel route 92 of the mowed grass collector 2 may be set so that the mowed grass collector 2 stands by in the work area W until the lawn mower 1 returns to the work area W, and then performs the collection work after the lawn mower 1 returns. Specifically, only the sections of the route where the blades 17a to 17c of the lawn mower 1 are rotating are combined, and the travel route 92 of the mowed grass collector 2 keeping the relative distance from the combined route is generated.

When the travel route without reflecting the work information is used in the case shown in FIG. 8, the mowed grass collector can be set not to perform the collection work in this section as described above. The method for generating the travel route 92 can be changed as appropriate to the circumstances.

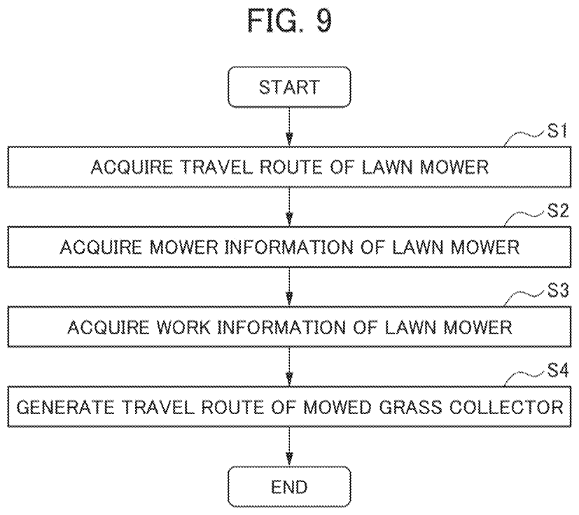

How the travel route 92 described above is generated will be described below. FIG. 9 is a flowchart of an example of the flow of the process of generating the travel route 92 of the mowed grass collector 2.

In Step S1, the collection route generator unit 33 acquires the travel route 91 of the lawn mower 1. The travel route 91 of the lawn mower 1 may be the travel route 91 set for the lawn mower 1 by the server 3 or the travel route 91 acquired from the lawn mower 1.

In Step S2, the mowing information acquisition unit 32 acquires the mower information of the lawn mower 1. The mower information includes the size of the lawn mower 1 and the direction in which the mowed grass is discharged. In Step S3, the mowing information acquisition unit 32 acquires the work information about the operation of the lawn mower 1. The work information includes the information about the operation of the blades 17a to 17c.

In Step S4, the collection route generator unit 33 sets the travel route 92 of the mowed grass collector 2 based on the relative distance calculated from the size of the lawn mower 1 and the direction in which the mowed grass is discharged, the travel route 91 of the lawn mower 1, and the work information of the lawn mower 1 (information about the operation of the blades 17a to 17c). As described above, when the travel route 91 of the lawn mower 1 includes a section where the blades 17a to 17c do not rotate, the travel route 92 of the mowed grass collector 2 is set to exclude the section.

Thus, an example of the process of generating the travel route by the collection route generator unit 33 has been described. Next, referring back to FIG. 5, the weather information acquisition unit 34 and the compression processing unit 35 will be described below.

The weather information acquisition unit 34 acquires weather information from an external server (not shown) via, for example, a communication network. The weather information includes weather such as sunny or rainy and a chance of rain. The weather information may be acquired from the user's input.

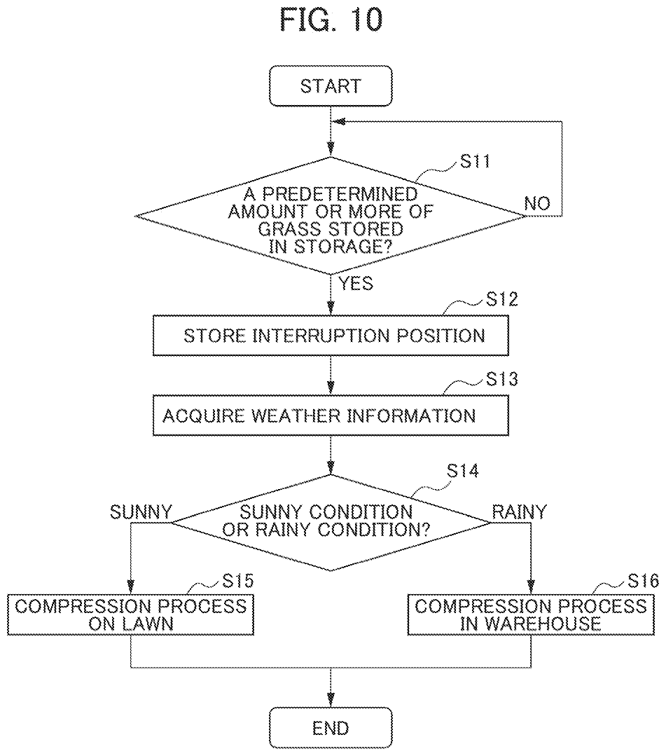

The compression processing unit 35 performs a compression process of operating the compressor 28. The compression processing unit 35 of the present embodiment allows the mowed grass collector 2 to perform the compression process based on the weather information. The compression process based on the weather information will be described below with reference to FIG. 10. FIG. 10 is a flowchart of an example of the flow of the compression process by the mowed grass collector 2.

In Step S11, the compression processing unit 35 monitors whether a predetermined amount or more of the mowed grass is stored in the storage 27 during the collection of the mowed grass by the mowed grass collector 2. For example, the compression processing unit 35 communicates with the mowed grass collector 2 to determine whether a value detected by the detector 271 indicates that the predetermined amount or more of the mowed grass is stored in the storage. Alternatively, the compression processing unit 35 may calculate an estimated amount of the stored grass based on, for example, the working time of the rotary brush 25 of the lawn mower 1, to determine whether the estimated amount is equal to or more than the predetermined amount.

When the predetermined amount or more of the grass is stored in the storage 27 (Yes is selected in Step S11), the compression processing unit 35 proceeds to Step S12. When the predetermined amount or more of the grass is not stored in the storage 27 (No is selected in Step S11), the compression processing unit 35 continues monitoring the storage 27.

In Step S12, the compression processing unit 35 allows the auxiliary storage 343 to store the current position of the mowed grass collector 2 as an interruption position for restart of the collection work after the compression process. When the lawn mower 1 is also stopped, the auxiliary storage 343 may also store the current position of the lawn mower 1 as an interruption position. After Step S12, the process proceeds to Step S13.

In Step S13, the weather information acquisition unit 34 acquires the weather information. The weather information acquisition unit 34 may read the weather information that was acquired in advance at predetermined timing and stored in the auxiliary storage 343 or may acquire the weather information at this timing from an external server (not shown).

In Step S14, the compression processing unit 35 determines whether the weather information acquired by the weather information acquisition unit 34 meets a sunny condition or a rainy condition. The sunny condition indicates that the weather information shows it is sunny, or it is sunny or there is a high probability of sunny weather with a chance of rain equal to or less than a predetermined value. The rainy condition indicates that the weather information shows it is rainy or there is a high probability of rainy weather with a chance of rain equal to or more than a predetermined value.

When the compression processing unit 35 determines that the weather information meets the sunny condition in Step S14, the process proceeds to Step S15. In Step S15, the mowed grass collector 2 is moved to the work area W or a lawn adjacent to the work area W. Then, the compressor 28 is operated to perform the compression process of discharging the mowed grass compressed into the columnar shape to the lawn. When the mowed grass collector 2 is in the work area W in Step S15, the compression process can be performed to discharge the roll-shaped mowed grass without moving the mowed grass collector 2. When the compression processing unit 35 determines that the weather information meets the rainy condition in Step S14, the process proceeds to Step S16. In Step S16, the mowed grass collector 2 is moved to a warehouse, which is a predetermined location with a roof. Then, the compressor 28 is operated to perform the compression process of discharging the mowed grass compressed into the columnar shape in the warehouse. Through the series of these steps, the mowed grass collector 2 finishes the compression process based on the weather information.

As described above, the server 3 which is the route generator of the present embodiment includes: the mowing information acquisition unit 32 that acquires mower information including at least the direction in which grass mowed by the lawn mower 1 is discharged; and the collection route generator unit 33 that acquires the travel route 91 of the lawn mower 1 and generates the travel route 92 for the autonomous mowed grass collector 2 to collect the mowed grass based on the acquired travel route 91 and the direction in which the mowed grass is discharged. This allows the travel route of the autonomous mowed grass collector 2 to correspond to the direction in which the lawn mower 1 discharges the mowed grass, making the collection of the mowed grass by the mowed grass collector 2 efficient.

In the present embodiment, the mower information includes the size of the lawn mower 1, and the collection route generator unit 33 acquires the size of the mowed grass collector 2 to calculate a relative distance between the lawn mower 1 and the mowed grass collector 2 during collection of the grass based on the size of the lawn mower 1, the size of the mowed grass collector 2, and the direction in which the grass is discharged, and generates the travel route of the mowed grass collector 2 based on the relative distance, the travel route of the lawn mower 1, and the direction in which the mowed grass is discharged. Thus, the travel route 92 for the mowed grass collector 2 to move relative to the autonomous lawn mower can be generated without performing any complicated processes.

In the present embodiment, when the mowed grass is discharged to one side in the lateral direction of the lawn mower 1, the collection route generator unit 33 generates the travel route 92 of the mowed grass collector 2 that deviates from the travel route 91 of the lawn mower 1 to the one side in the lateral direction. Thus, the mowed grass collector 2 can be precisely positioned relative to the position of the mowed grass discharged and left by the lawn mower 1 on the one side in the lateral direction. This allows more reliable collection of the mowed grass, reducing the amount of grass left uncollected more efficiently.

In the present embodiment, the mowing information acquisition unit 32 further acquires work information for distinction between a section where the lawn mowing work is performed and a section where no lawn mowing work is performed on the travel route 91, and the collection route generator unit 33 generates the travel route 92 of the mowed grass collector 2 reflecting (e.g., excluding) the section where no lawn mowing work is performed so that the distance travelled by the mowed grass collector 2 is reduced. This allows generation of the travel route 92 that efficiently follows the actually discharged mowed grass by excluding the section where no lawn mowing work is performed and no collection work is required.

In the present embodiment, the mowing information acquisition unit 32 further acquires work information for distinction between a section where lawn mowing work is performed and a section where no lawn mowing work is performed on the travel route 91, and the collection route generator unit 33 sets a section that corresponds to the section where no lawing mowing work is performed and requires no collection work on the travel route 92 of the mowed grass collector 2. Thus, the collection work is performed while excluding the section where no lawn mowing work is performed and no collection work is required. This can save energy that the mowed grass collector requires to collect the grass.

In the present embodiment, the server 3 may further include the weather information acquisition unit 34 that acquires weather information and the compression processing unit 35 that determines a place to compress and discharge the mowed grass based on the weather information. Thus, without the need for the user to consider the weather, the mowed grass can be discharged and dried at the same place if the weather continues to be sunny, and can be kept from becoming wet and taking more time to dry if the rainy weather is expected.

Embodiments of the present invention have just been described above, but the present invention is not limited to these exemplary embodiments.

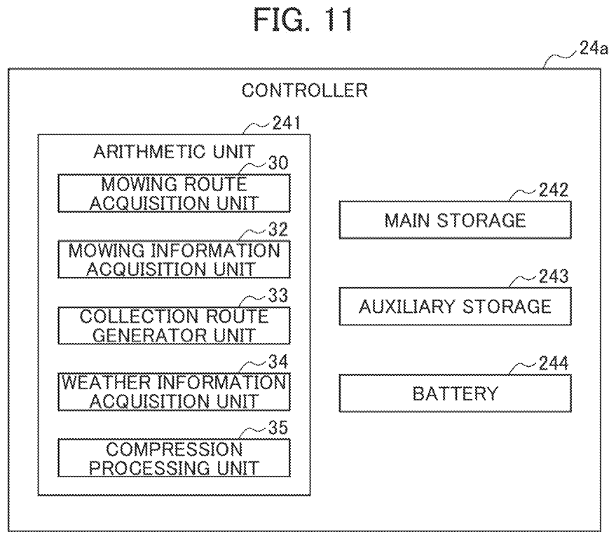

FIG. 11 is a functional block diagram of a controller 24a of a mowed grass collector 2 of a variation. The variation shown in FIG. 11 is configured in the same manner as the embodiment except for the controller 24a. Components of the controller 24a will be indicated by the same reference numerals as those of the embodiment and may not be described in detail.

In this variation, the controller 24a of the mowed grass collector 2 serves as the route generator of the mowed grass collector 2. The controller 24a includes, as functional units operated by an arithmetic unit 241, a mowing route acquisition unit 30, a mowing information acquisition unit 32, a collection route generator unit 33, a weather information acquisition unit 34, and a compression processing unit 35.

The mowing route acquisition unit 30 communicates with a lawn mower 1 or a server 3 which are external devices to acquire a travel route 91 of the lawn mower 1. The mowing information acquisition unit 32 also communicates with the lawn mower 1 or the server 3 to acquire mower information and work information. The collection route generator unit 33 generates a travel route 92 of the mowed grass collector 2 by the same process described in the embodiment and shown in FIG. 9.

The weather information acquisition unit 34 acquires weather information from the external server. When a predetermined amount or more of the mowed grass is stored in a storage 27, the compression processing unit 35 performs the compression by the same process described in the embodiment and shown in FIG. 10 based on the weather information.

Thus, the mowed grass collector 2 of the variation includes the controller 24a including: the mowing information acquisition unit 32 that acquires the mower information including at least the direction in which grass mowed by the lawn mower 1 is discharged; and the collection route generator unit 33 that acquires the travel route 91 of the lawn mower 1 and generates the travel route 92 for the mowed grass collector 2 to collect the mowed grass based on the acquired travel route 91 and the direction in which the mowed grass is discharged. This configuration also provides the same advantages as the configuration of the embodiment.

Although the embodiment and the variation has been described on the premise that the lawn mower 1 is autonomous, but the present invention is not limited to the autonomous lawn mower. The travel route 92 of the mowed grass collector can be generated using the travel route 91 of a self-propelled riding lawn mower 1 or a remote-controlled lawn mower 1. When the work of the lawn mower 1 or the mowed grass collector 2 is interrupted for charging, rainy weather, or by the instruction of an operator, information indicating that the work is interrupted and the position of one or both of the lawn mower 1 and the mowed grass collector 2 may be stored. Thus, the interruption position is stored. When the work of both of the lawn mower 1 and the mowed grass collector 2 is interrupted, the work can be restarted by recreating their positional relationship with a relative distance between them maintained based on the stored interruption positions.

The components of the present embodiment can be replaced with any known components as appropriate and can be suitably combined with the variation within the spirit of the present invention.

### EXPLANATION OF REFERENCE NUMERALS

1, 1a Lawn mower
2 Mowed grass collector
3 Server (route generator)
24a Controller (route generator)
30 Mowing route acquisition unit
31 Mowing route setting unit
32 Mowing information acquisition unit
33 Collection route generator unit
34 Weather information acquisition unit
35 Compression processing unit

What is claimed is:

1. A route generator, comprising: a mowing information acquirer that acquires mower information including at least a direction in which grass mowed by a lawn mower is discharged; and
a collection route generator that acquires a travel route of the lawn mower and generates a travel route for an autonomous mowed grass collector to collect the mowed grass based on the acquired travel route and the direction in which the mowed grass is discharged.

2. The route generator according to claim 1, wherein the mower information includes a size of the lawn mower, and
the collection route generator
acquires a size of the mowed grass collector to calculate a relative distance between the lawn mower and the mowed grass collector during collection of the mowed grass based on the size of the lawn mower, the size of the mowed grass collector, and the direction in which the grass is discharged, and generates the travel route of the mowed grass collector based on the relative distance, the travel route of the lawn mower, and the direction in which the mowed grass is discharged.

3. The route generator according to claim 2, wherein in a case where the mowed grass is discharged to one side in a lateral direction of the lawn mower, the collection route generator unit generates the travel route of the mowed grass collector that is deviated from the travel route of the lawn mower to the one side in the lateral direction.

4. The route generator according to claim 1, wherein the mowing information acquirer further acquires work information for distinction between a section where lawn mowing work is performed and a section where no lawn mowing work is performed on the travel route, and
the collection route generator generates the travel route of the mowed grass collector reflecting the section where no lawn mowing work is performed so that a travel distance of the mowed grass collector is reduced.

5. The route generator according to claim 1, wherein the mowing information acquirer further acquires work information for distinction between a section where lawn mowing work is performed and a section where no lawn mowing work is performed on the travel route, and
the collection route generator sets a section that corresponds to the section where no lawn mowing work is performed and requires no collection work on the travel route of the mowed grass collector.

6. The route generator according to claim 1, further comprising: a weather information acquirer that acquires weather information; and
a compression processor that determines a place to compress and discharge the mowed grass based on the weather information.

7. A mowed grass collector including a route generator comprising: a mowing information acquirer that acquires mower information including at least a direction in which grass mowed by a lawn mower is discharged; and
a collection route generator that acquires a travel route of the lawn mower and generates a travel route for the mowed grass collector to collect the mowed grass based on the acquired travel route and the direction in which the mowed grass is discharged.
